(19) United States
(12) Patent Application Publication
(10) Pub. No.: US 2010/0316439 A1
(43) Pub. Date: Dec. 16, 2010

(54) MOUNTING SYSTEM

(75) Inventors: Jack Schron, SR., Medina, OH (US); Terry Schron, Garden Grove, CA (US); Harry P. Fuller, Newbury, OH (US); Esther Schron, Medina, OH (US)

Correspondence Address: RANKIN, HILL & CLARK LLP, 23755 LORAIN ROAD, SUITE 200, NORTH OLMSTED, OH, 44070, US

(73) Assignee: JERGENS, INC., Cleveland, OH (US)

(21) Appl. No.: 12/754,026

(22) Filed: Apr. 5, 2010

Related U.S. Application Data
(60) Provisional application No. 61/166,288, filed on Apr. 3, 2009.

(51) Int. Cl. F16B 5/02

(52) U.S. Cl. 403/202

(57) ABSTRACT

A mounting system with a receiver arrangement with an annular gland nut and an annular receiver bushing. The bushing having an inner passage and an oppositely facing outer surface. The outer bushing surface having at least one receiver-bearing surface shaped to engage a bearing surface of the mounting opening to align the receiver laterally within the opening. The bushing further including a support edge to position the receiver axially within the mounting opening. The annular gland nut having an OD thread configured to threadingly engage an ID thread in the mounting opening and having a contact edge to engage the receiver and force the support edge of the receiver against the bottom ledge of the mounting opening thereby securing the receiver axially in the mounting opening.

This application claims priority in provisional patent application Ser. No. 61/166,288 that was filed on Apr. 3, 2009, which is incorporated by reference herein.

This invention of this application relates generally to the art of mounting systems and, more particularly, to a mounting system used as a quick-change mounting and location system for tooling and the like.

Mounting systems are known in the art and have been used over the years to accurately mount one structure to a substrate structure. With respect to the invention of this application, it has been found that the mounting system works particularly well in the accurate mounting of a fixture plate onto a subplate wherein the subplate can be fixed relative to a machining table wherein this application will be described with reference to these structures but has broader application wherein this description should not be limiting in nature.

### INCORPORATION BY REFERENCE

Quick-change locking systems have been used over the years and are shown in the attached pages, which we relate to Assignee's BALL LOCK mounting system, which are incorporated by reference herein, for showing the same. Also incorporated by reference is U.S. Pat. No. 2,707,419, to Schron which discloses a system for locating a fixture plate and is incorporated by reference herein for showing the same.

### BACKGROUND OF THE INVENTION

Again, the invention of this application relates to mounting system and will be described in connection with fixture plates and subplates; however, the invention of this application has a much broader application and can be used in connection with a wide range of quick-change systems and even long-term mounting systems, which are known in the art. Mounting systems have been used over the years for a wide range of applications and can be used to quickly and accurately locate and lock a fixture plate to a subplate. In general terms, the mounting systems are comprised of three general components. These include a locating shank, a liner bushing, and a receiver bushing.

The receiver bushing is mounted to the subplate or machine table, and the liner bushing is mounted to the fixture plate. The locating shank is then positioned through the liner and into the receiver to provide both an accurate location and a locking of the fixture plate to the subplate. This locking action typically takes the form of either a threaded engagement or Assignee's BALL LOCK locking system.

As is known in the art, more than one set of the mounting systems can be used to accurately locate the fixture plate to the subplate. In this respect, if a single mounting system is used without any other locating device, the fixture plate would rotate about the shank axis. This would cause the fixture plate to become misaligned with the subplate. Therefore, more than one mounting system is typically used in these mounting arrangements. However, it has been found that the mounting arrangements can include both positioning mounting systems and holding mounting systems. More particularly, in that, the positioning of a fixture plate to a subplate is essentially a two-dimensional orientation; two mounting systems can be used to control the positioning of the fixture plate relative to the subplate. Then, additional mounting systems can be used to help hold the fixture plate relative to the subplate even though these other mounting systems do not control the positioning of the fixture plate relative to the subplate. For these systems that are used for holding only, the liner does not need to be positioned within the fixture plate. Conversely, the opening in the fixture plate just needs to be larger than the shaft portion of the shank to allow the free passage of the shank through the fixture plate. This provides only a hold-down force for this particular mounting arrangement and does not provide for the alignment of the fixture plate relative to the subplate.

While these mounting systems have been affective in the field, they can be costly to produce and install. In this respect, the prior art mounting systems include a receiver bushing that it is bolted to the subplates by multiple fasteners spaced about the receiver axis. As is referenced above, the mounting systems can be used for both securing the fixture plate to the subplate and for alignment of the fixture plate relative to the subplate. When the mounting system is used for alignment, it is important to accurately locate the individual components of the system so that they line up with one another. Thus, the axis of the liner and the axis of the receiver must be aligned to one another as close as possible. Further, this alignment must fall within a certain tolerance for the resulting fixture plate alignment to be within a desired tolerance. As a result, each machining operation used to create the mounting opening for the receiver bushing must be aligned to specified tolerances. By utilizing multiple fasteners to hold the receiver bushing within the subplate, multiple machining operations are necessary to cut the threads needed to receive these multiple fasteners within the subplate. Further, these cut threads must be aligned with the opening in the receiver bushing. While the position of the cut threads may not be critical in all uses of the mounting system (such as mounting systems used only to hold down the fixture plate), the drilling of the holes and cutting of the threads are still time consuming and adds considerable labor cost to the installation of the mounting system. Further, the use of fasteners spaced about the receiver axis only provides spaced hold-down force about this axis and can weaken the receiver wall in that holes must be drilled therethrough to allow the passage of these fasteners. Further, there is a competing interest between increasing the number of fasteners to increase the hold-down point and the weakening of the receiver wall. It has been found that three fasteners provide the best balance between contact points, installation cost, and weakening the receiver wall.

### SUMMARY OF THE INVENTION

In accordance with the present invention, provided is a mounting system that provides the useful benefits of the prior art mounting systems but which overcomes many of the shortcomings of the prior art systems. More particularly, provided is a mounting system for securing a fixture plate to a subplate, which eliminates the use of traditional fasteners and replaces them with an annular gland nut to secure the receiver bushing to the subplate.

More particularly, the mounting system according to the present invention can include a receiver bushing arrangement for the mounting system for securing a plate to the subplate, which utilizes an annular receiver bushing having an inner passage extending about a passage axis. The bushing further includes a radially outwardly facing peripheral bushing surface and the inner passage is shaped to receive the shaft portion of a locking shank. This inner passage can also have a mating locking arrangement allowing the locking arrangement of the shank to selectively interengage with the receiver bushing and secure the shank relative to the receiver thereby securing the fixture plate to the subplate.

Further, the outer bushing surface can have at least one receiver-bearing surface shaped to engage the bearing surface of the mounting opening to align the receiver laterally within the mounting opening. The bushing can further include a downwardly facing support edge to position the receiver axially within the mounting opening.

The system further includes an annular gland nut having an outer diameter thread configured to threadingly engage an inside diameter thread in the peripheral surface of the associated mounting opening and having a contact edge configured to engage the receiver when the gland nut is tightened in the mounting opening. The gland nut can be used to force the support edge of the receiver against the bottom ledge of the mounting opening as the gland nut is tightened into the mounting opening, thereby securing the receiver axially in the mounting opening.

According to another aspect of the present invention, the mounting system can include a receiver with a first and a second peripheral bushing surface wherein the gland nut can extend about one of these peripheral bushing surfaces thereby allowing the receiver to extend upwardly towards the upper subplate surface of the subplate.

According to yet a further aspect of the present invention, the gland nut can be a unified structure with the receiver wherein a single structure can be threadingly engaged with the subplate.

These and other objects, features and advantages of the invention will become apparent to those skilled in the art upon a reading of the detailed description of the invention set forth below, taken together with the drawings which will be described in the next section.

### BRIEF DESCRIPTION OF THE DRAWINGS

The invention may take physical form in certain parts and arrangements of parts, and a preferred set of embodiments of which will be described in detail and illustrated in the accompanying drawings, which form a part of the specification and wherein:

FIG. 1 is a top perspective view in exploded format showing mounting systems according to the present invention positioned relative to a fixture plate, a subplate and a machining table;

FIG. 2 is a top view of a prior art receiver arrangement;

FIG. 3 is a sectional view taken along lines 3-3 in FIG. 2;

FIG. 4 is an exploded, partially sectioned, view of a mounting system according to certain aspects of the present invention;

FIG. 5 is a top view of a receiver arrangement according to an embodiment of the present invention;

FIG. 6 is a sectional view taken along line 6-6 in FIG. 5;

FIG. 7 is an exploded perspective view of the receiver arrangement shown in FIG. 5;

FIG. 8 is an exploded, partially sectioned, view of a mounting system according to other embodiments of the invention of this application;

FIG. 9 is a sectional view of yet another embodiment of the invention of this application; and,

FIG. 10 is a top view of a receiver arrangement according to yet a further embodiment of the present invention.

### DETAILED DESCRIPTION OF THE INVENTION

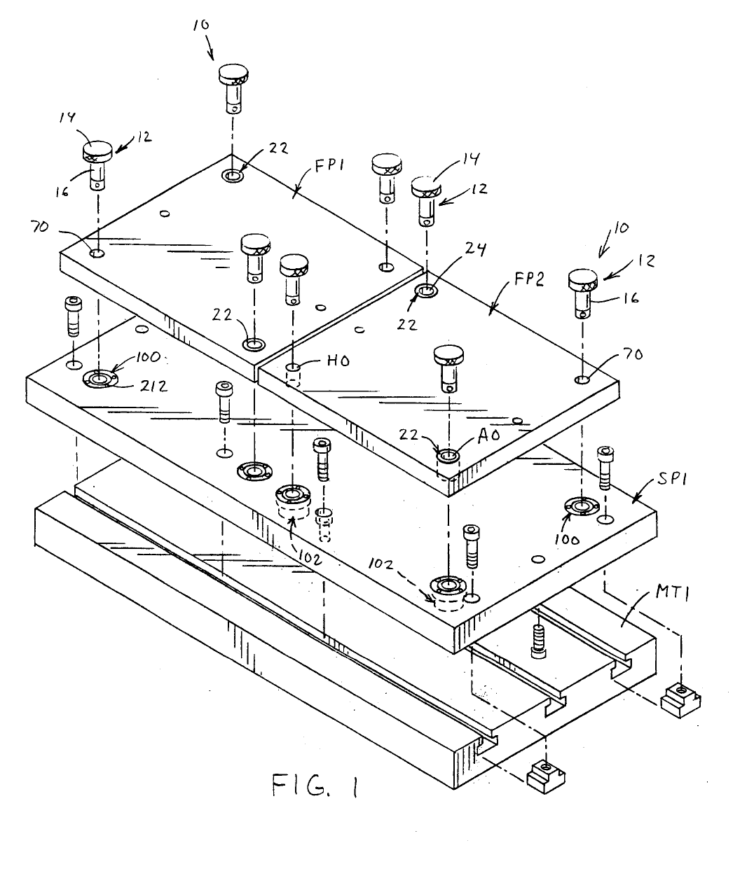

Referring now to the drawings wherein the showings are for the purpose of illustrating preferred and alternative embodiments of the invention only and not for the purpose of limiting the same, shown in FIG. 1 is a hold-down arrangement wherein multiple mounting systems are used to secure fixture plates FP1 and FP2 to a single subplate, SP1, which in turn is mounted to a machining table, MT1.

In greater detail, while a machining table is shown in these figures, the invention of this application can be used in connection with any support structure, which is known in the art. Further, as is referenced above, the invention of this application is being described in relation to fixture plates and subplates; however, the invention this application can be used with other mounting structures wherein the plate structure used in this application is merely an example of the use of the invention of this application.

As is discussed above, the hold-down arrangement, which includes multiple mounting systems according to the invention of this application, can include both alignment openings AO and/or hold-down openings HO in the fixture plate, which is to be secured to the subplate. In this respect, it has been found that in order to properly align the fixture plate relative to the subplate, two alignment openings should be produced in the fixture plate. These two alignment openings include a liner 22, which will be discussed in greater detail below, and the hold-down openings HO do not need to include liner 22.

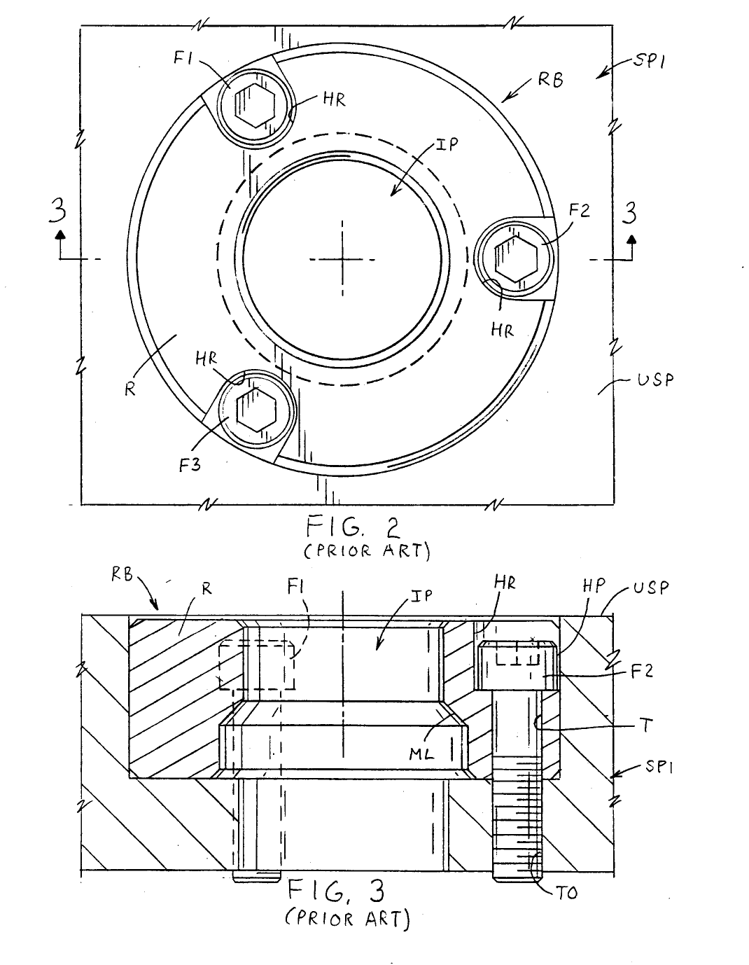

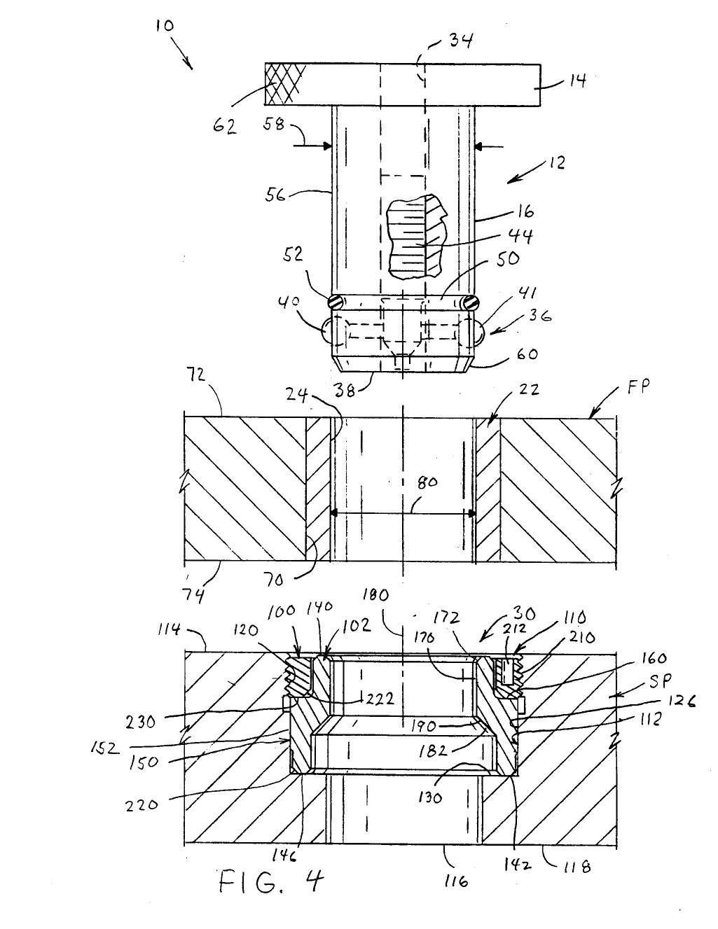

With reference to FIGS. 2 and 3, shown is a prior art receiver bushing arrangement RB. This bushing arrangement is secured to subplate SP1 by way of fasteners F1-F3. In this arrangement, a receiver R includes a plurality of through holes T drilled therethrough with head recesses HR shaped to receive a head portion HP of the fasteners to allow the fasteners to be counter-sunk below an upper surface USP of subplate SP1. As a result, receiver R must include multiple drilling operations and/or milling operations to both drill the through hole and create the head recess. As can be appreciated, these drilling operations and/or milling operations must be performed with a relatively high degree of accuracy in order to secure the receiver bushing to the subplate. In addition, subplate SP1 also needs corresponding threaded openings TO shaped to receive fasteners F1-F3 and these threaded openings must be in alignment with the through holes in the receiver. In addition to the added expense of the through holes and threaded holes, the drilling of through holes T in receiver R structurally impacts the annular configuration of the receiver bushing thereby potentially producing stress points and/or difficulties in the heat-treated process for this component. As will be discussed in greater detail below, the receiver includes an inner passage IP that can include any one of a number of mating-locking arrangements ML, which are known in the art.

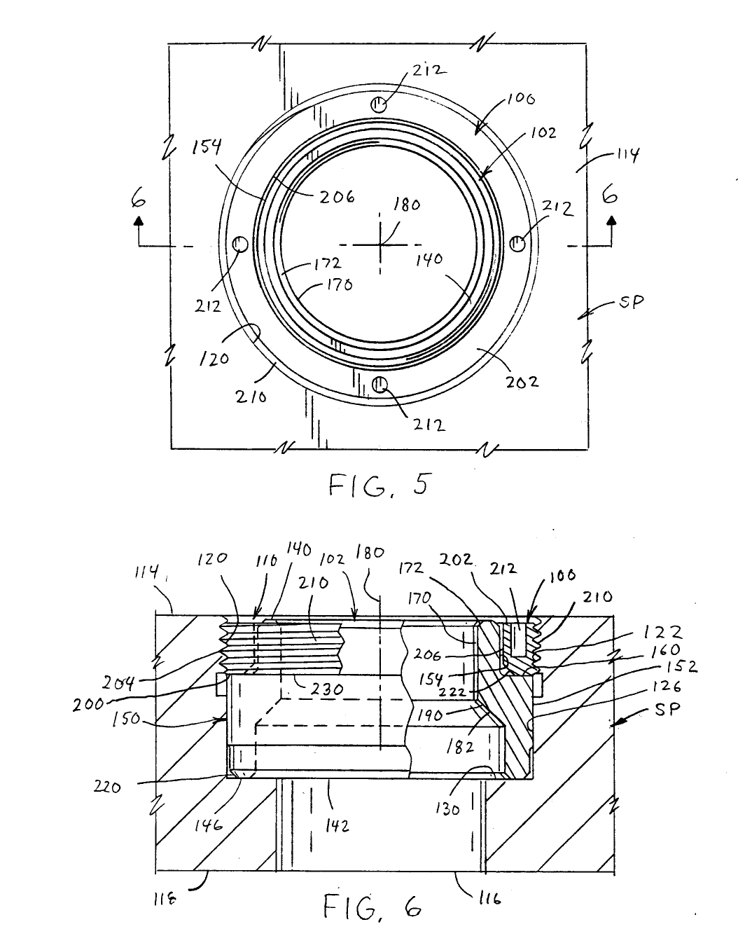

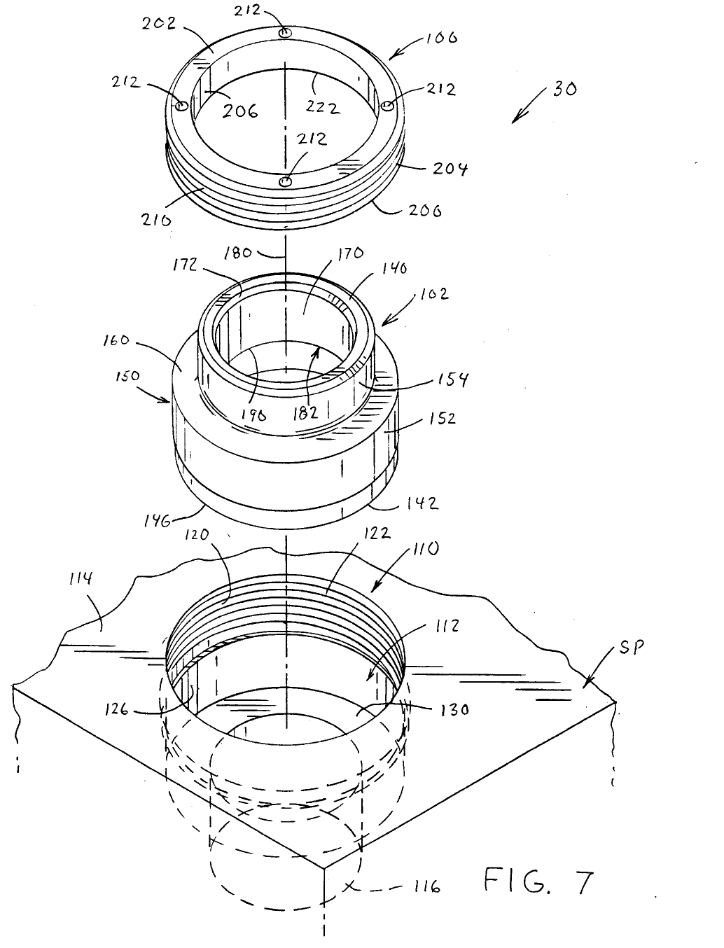

With reference to FIGS. 4-7, shown is a mounting system 10 including a shank 12, with a head portion 14 and a shaft portion 16. Mounting system 10 can further include liner 22 having an inner liner passage 24 and include a receiver arrangement 30. As is referenced above, liner 22 can be positioned in fixture plate FP and receiver arrangement is positioned within subplate SP such that shank 12 can be used to secure the fixture plate to the subplate, which will be discussed in greater detail below.

Shank 12 can be any shank known in the art or even shanks that will be known in the art in the future. Head portion 14 of shank 12 can include a tooling opening 34 that can be any one of a number of tooling openings. In this particular embodiment, tooling opening 34 is a passage within shank 12, which allows a tool to be inserted within the passage to actuate a locking arrangement 36, which can be located near a distal end 38 of shaft portion 16. This particular locking arrangement includes protuberances 40 and 41 which can be spherical and which are selectively movable between an unlocked condition and a locked condition. Shown in FIG. 4, protuberances 40 and 41 are in a locked condition wherein they are extended outwardly from shaft portion 16. These protuberances can be activated with a threaded member 44 which can move them between the locked condition wherein the protuberances extended outwardly of the shaft portion and an unlocked condition wherein protuberances 40 and 41 move inwardly into the shaft portion.

Shaft portion 16 can further include a grommet grove 50 shaped to receive a grommet 52 that can be used to produce a resistance fit between shank 12 and receiver arrangement 30. This can be used to hold the shank relative to the receiver while the shank is activated between the unlocked and the lock conditions. Shaft portion 16 can be cylindrical having a radially outwardly shaft surface 56 with a diameter 58. Shaft 16 can further include a chamfer 60, which allows the shaft portion to be more easily inserted into liner 22 and/or receiver arrangement 30. In this embodiment, head portion 14 is a circular head portion having a knurling 62 on its outer surface. As will be discussed in greater detail below, shank 12 can be any shank known in the art without detracting from the invention of this application, which includes other locking arrangements and other head configurations. Further, shank 12 can have a wide range of coatings applied to the head portion and/or the shaft portion including, but not limited to, a black oxide coating. The material used to produce shank 12 can also be any material known in the art, including carbon steel that is heat-treated to a Rockwell-hardness on the C scale of between 35 and 60 Rc.

Liner 22 can also be any liner known in the art and can be joined to fixture plate FP by any method known in the art. This includes, but is not limited to, press fitting the liner into a through hole 70 machined into fixture plate FP. In this respect, fixture plate FP can have an upper surface 72 and an oppositely facing lower plate surface 74 wherein through hole 70 extends from upper plate surface 72 to lower plate surface 74. Through hole 70 can be sized to allow the press-fitted connection between the liner and the through hole to secure these parts relative to one another. However, it should be noted that any other means to join the liner to the fixture plate can be used without detracting from the invention of this application. Furthermore, as referenced above, through hole 70 does not need to include liner 22 wherein a complete hold-down arrangement would include some mounting systems 10 with liners and others without. In fact, it is recommended that only two liners be used for each plate joined to a subplate. Further, liner 22 can be made from a wide range of materials including, but not limited to, carbon steel. This material can be heat-treated as is known in the art including a heat treat wherein the liner has a Rockwell-hardness on the C scale of between 60 and 70 RC.

Inner passage 24 of liner 22 has a diameter 80 that can be configured to be only slightly larger than diameter 58 of shaft portion 16 thereby producing a close fit between shaft 16 and liner 22, which allows the mounting system to locate fixture plate FP relative to subplate SP in a known position. In that these two diameters are closely matched to one another, chamfer 60 on distal end 38 can be used to help guide shaft portion 16 into the inner liner passage.

Receiver arrangement 30 in one set of embodiments is a two-piece arrangement including an annular gland nut 100 and an annular receiver bushing 102. More particularly, subplate SP includes one or more mounting opening 110, which can be circular openings, having an opening peripheral surface 112 that can extend downwardly from upper subplate surface 114 towards a bottom extent 116. Mounting opening 110 can be a through hole or a pocket wherein in the embodiment shown, bottom extent 116 is at lower subplate surface 118; however, in other embodiments, the bottom extent is spaced from the lower subplate surface without detracting from the invention of this application. Opening peripheral surface can include multiple sections with or without the same diameter or size. In the embodiment shown, opening peripheral surface 112 includes a threaded portion 120 having an inside diameter thread 122 and an opening bearing surface 126. In this set of embodiments, threaded portion 120 is adjacent to upper subplate surface 114 and bearing surface 126 is spaced from both upper surface 114 and lower subplate surface 118. Mounting opening 110 can further include a bottom ledge 130 that is spaced from bottom extent 116 and which can be used to align receiver bushing 102 axially, which will be discussed in greater detail below.

Receiver bushing 102 extends between a top extent 140 and a bottom extent 142, which can define an axial dimension that is less than the thickness of the subplate. In this particular embodiment, the thickness of the subplate is greater than the height of the receiver bushing. Receiver bushing 102 further includes a downwardly facing support edge 146, which can be used to align the bushing axially which will also be discussed in greater detail below. Receiver bushing 102 further includes a radially outwardly facing peripheral surface 150 having a receiver-bearing surface 152 wherein bearing surface 152 can be utilized to laterally align the receiver bushing within the mounting opening, which will be discussed in greater detail below. Further, radially facing surface 150 can further include an upper section 154 that can include top extent 140 and which can extend inwardly of annular gland nut 100. In one embodiment, upper section 154 has a diameter smaller than bearing surface 152 thereby creating a receiver ledge 160, which will be discussed in greater detail below.

Receiver bushing 102 further includes an inner passage 170 shaped to receive a portion of shaft 16 of shank 12. Inner passage 170 can include a top chamfer 172, which can work in combination with shaft chamfer 60 to help align and guide shank 12 into the inner passage. Inner passage 170 extends about a passage axis 180 and includes a mating locking arrangement 182 designed to lockingly engage with the locking arrangement of shank 12. As discussed above, this locking arrangement can be any locking arrangement known in the art without detracting from the invention of this application. In the locking arrangement shown, protuberances 40 and 41 are aligned to engage conical section 190 of passage 170 thereby both securing the shaft in the inner passage and producing a clamping force between subplate and the shank thereby creating a hold-down force between the fixture plate and the subplate.

Receiver bushing 102 can be made from any material known in the art, which includes carbon steel. Further, the receiver bushing can have any treatment known in the art including a black oxide coating and a hardness on the Rockwell-C scale of between 45 and 60 Rc.

Annular gland nut 100 is configured to secure the receiver bushing axially relative to passage axis 180. More particularly, gland nut 100 includes a bottom edge 200 and an oppositely facing top edge 202 with a radially outwardly facing side edge 204 and a radially inwardly facing side edge 206. Edge 204 includes a threaded portion 210, which can cover the entire edge 204 or a portion thereof. Gland nut further includes at least one tool receiving arrangement 212, which can include, but is not limited to, a plurality of tool receiving pockets extending about the top edge. In one particular set of embodiments, the tool receiving arrangement includes four evenly spaced pockets about top edge 202. This tool receiving arrangement allows annular gland nuts to be fully positionable below upper support plate surface 114 when it is tightened against bushing 102, thereby allowing lower plate surface 74 to directly engage upper subplate surface 114. A spanner wrench (not shown) can be used to engage arrangements 212 to tighten or loosen gland nut 100. As can be appreciated, an as will be discussed more below in relation to other embodiments, other tool arrangements could be used without detracting from the invention of this application.

In operation, receiver bushing 102 is positioned in mounting opening 110 wherein this can be facilitated by a lower receiver chamfer 220. The receiver bushing is urged into mounting opening 110 until support edge 146 engages bottom ledge 130 of the mounting opening. The engagement between the support edge and the ledge can be used to align the receiver bushing within the mounting opening axially. Similarly, bearing surface 126 works in connection with bearing surface 152 to align the receiver bushing laterally within the mounting opening. Once in place, annular gland nut 100 can be positioned in the mounting opening. As with the other components of the invention of this application, annular gland nut can include a chamfer 222 to help guide gland nut 100 relative to the top extent 140 of receiver bushing 102. This can guide the alignment between surfaces 154 and 206 of bushing 102 and nut 100, respectively. Further, when installed, surface 206 can be spaced from surface 154 forming a gap therebetween. Gland nut 100 is then threadingly engaged with threads 122 of opening 110 until a contact edge 230 on bottom 200 engages receiver ledge 160 thereby urging receiver bushing 102 downwardly into the mounting opening thus forcing downwardly facing support edge 146 against bottom ledge 130 of the mounting opening. Thus, annular gland nut 100 maintains the orientation of receiver bushing axially relative to the passage axis. Once the annular gland nut is tightened, the receiver bushing is locked within the mounting opening and the mounting system is in condition for use. While not shown, the receiver bushing and/or the mounting opening and/or the annular gland nut can include an anti-rotation configuration to help prevent the relative rotation of the receiver bushing within the mounting opening. While with the shown locking arrangement, rotation is not a concern, other locking arrangements could necessitate the use of an anti-rotation configuration within the receiver arrangement. This can include, but is not limited to, O-rings producing a resistance fit, locking key slots, knurling and other methods known in the art.

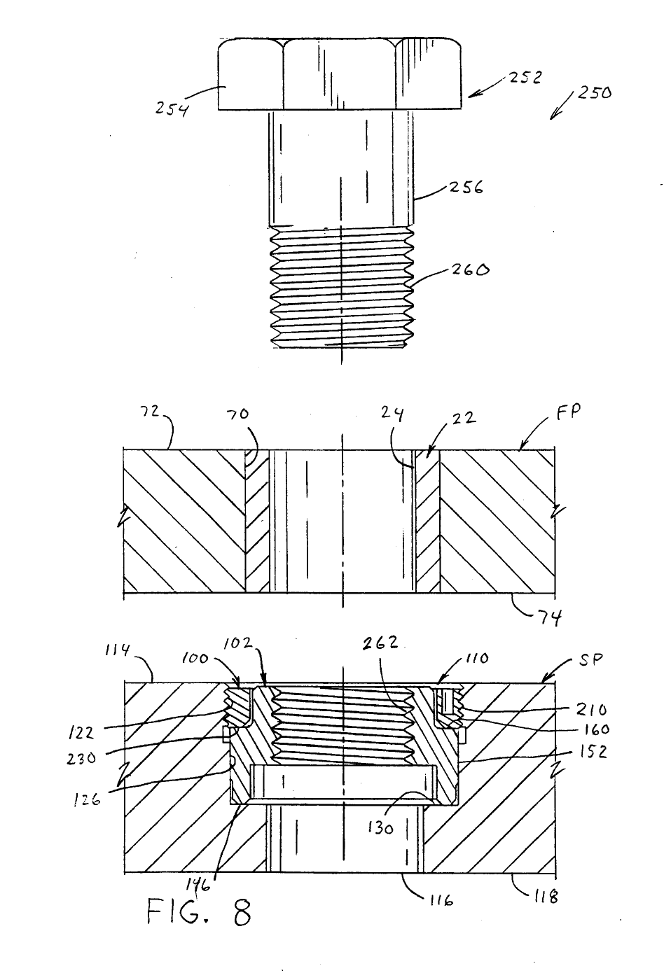

With reference to FIG. 8, yet another set of embodiments are shown. However, in the interest of brevity, the discussions with reference to FIG. 8 are limited to the differences in the locking arrangement. Further, like components are referenced with the same reference numbers discussed above. More particularly, mounting system 250 includes a shank 252 having a head portion 254 and a shaft portion 256. In this embodiment, shank 252 includes a threaded locking arrangement 260 configured to lockingly engage a threaded mating locking arrangement 262. In order to facilitate the threaded locking between the shank and the receiver bushing, head portion can include any tool-receiving configuration known in the art. In this particular shown embodiment, the head portion includes a hex head configuration allowing a wrench to engage and rotate shank 252.

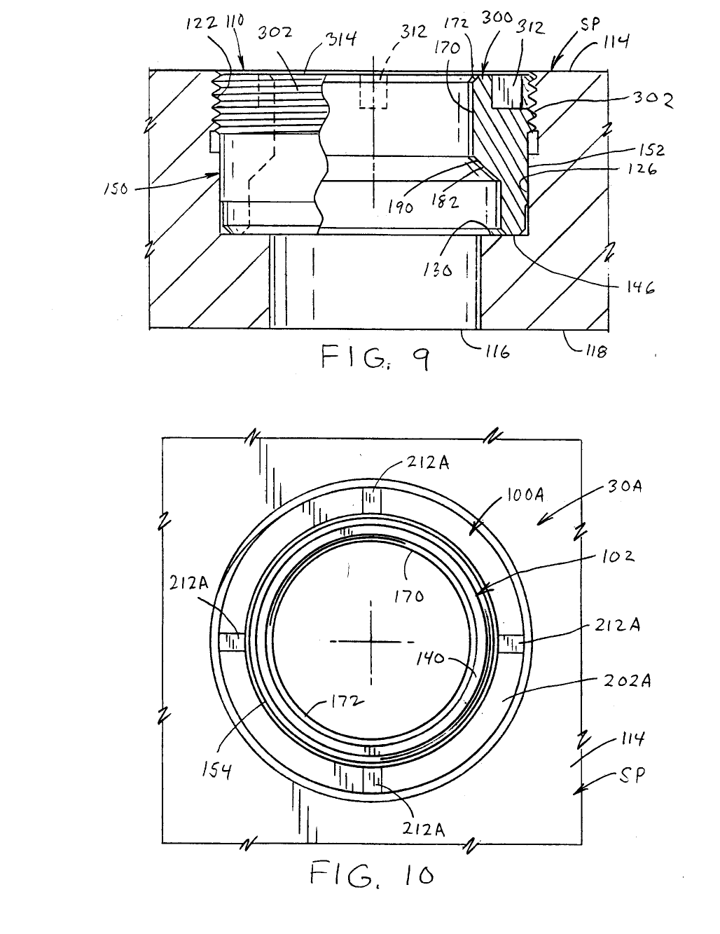

With reference to FIG. 9, shown is yet another set of embodiments of the invention of this application. In this respect shown is receiver bushing 300 which has a unified structure between the receiver bushing and the annular gland nut. More particularly, receiver bushing 300 includes a threaded portion 302 configured to threadingly engage with ID threads 122 of mounting opening 110. As can be appreciated, receiver bushing 300 can include tool receiving arrangement 312 that are larger in that a top surface 314 of bushing 300 is larger than top surface 202 of gland nut 100. While the configuration of bushing 300 is shown to interengage with an mounting opening configured similar to mounting opening 110, this is not required.

With reference to FIG. 10, shown is a receiver arrangement 30A according to yet another set of embodiments of the invention of this application which includes a tool receiving arrangement 212A in a gland nut 100A. In this embodiment, arrangement 212A includes slotted pockets positioned about top surface 202A of gland nut 100A. In one particular set of embodiments, the tool receiving arrangement includes four evenly spaced slotted pockets positioned about top edge 202A.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted nearly as illustrative of the invention and not as a limitation.

Having thus described the invention, it is so claimed:

1. A mounting system for securing a plate to a subplate, the associated plate having an upper plate surface and an opposing lower plate surface with a through hole extending from the upper plate surface to the lower plate surface, the associated subplate having an upper subplate surface facing said lower plate surface and having a mounting opening extending into the upper subplate surface, the mounting opening having an opening peripheral surface generally extending between the upper subplate surface and a opening bottom extent, the mounting opening further including a bottom ledge and at least one opening bearing surface, said system comprising: a shank having a shaft portion extending from a head portion to a distal end spaced from said head portion, said shaft portion extending along a shaft axis between said head portion and said distal end and having a radial shaft surface coaxial with said shaft axis, said shaft surface being smaller than the through hole allowing the shaft portion to pass through the through hole of the plate, said shank further including a locking arrangement selectively positionable between a locked condition and an unlocked condition; an annular receiver bushing including an inner passage extending about a passage axis, said bushing further include a radially outwardly facing peripheral bushing surface, said inner passage being shaped to receive said shaft portion such that said shaft axis is closely aligned with said passage axis and said passage having a mating locking arrangement allowing said locking arrangement to selectively interengage with said receiver bushing and secure said shank relative to said receiver thereby securing the associated plate to the associated subplate, said outwardly facing bushing surface having at least one receiver bearing surface shaped to engage the opening bearing surface of the associated subplate and align said receiver laterally in the opening, said bushing further including a downwardly facing support edge; and an annular gland nut having an outer diameter thread configured to threadingly engage an inside diameter thread in the opening peripheral surface of the mounting opening and having a contact edge configured to engage said receiver when said gland nut is tightened in the mounting opening, said gland nut forcing said support edge of said receiver against the bottom ledge of the mounting opening as said nut is tightened into the mounting opening thereby securing said receiver axially in the mounting opening.

2. The mounting system of claim 1, further including a liner positioned in the through hole of the associated plate, said liner being fixed relative to the through hole and having an inner liner passage shaped to closely fit said shaft of said shank.

3. The mounting system of claim 1, wherein said receiver bushing includes a bushing top extent and an opposite bushing bottom extent including said support edge.

4. The mounting system of claim 3, wherein the bottom ledge of the mounting opening is spaced from the opening bottom extent.

5. The mounting system of claim 3, wherein said peripheral bushing surface of said annular receiver bushing is a first peripheral bushing surface near said bushing bottom extent and said receiver further includes a second peripheral bushing surface near said bushing top extent, said gland nut extending about said second peripheral bushing surface, said first bushing surface including said receiver bearing surface.

6. The mounting system of claim 5, wherein said first peripheral bushing surface has a first diameter and said second peripheral bushing surface has a second diameter, said first diameter being greater than said second diameter forming a receiver ledge between said first and second peripheral surfaces, said contact edge of said gland nut engaging said receiver ledge thereby forcing said receiver against the bottom ledge of the associated mounting opening.

7. The mounting system of claim 1, wherein said shaft surface is cylindrical and coaxial with said shaft axis and has a shaft diameter, said inner passage is cylindrical and coaxial with said passage axis with a passage diameter, passage diameter being slightly greater than said shaft diameter for said receiving of said shaft portion in said passage.

8. The mounting system of claim 1, wherein said annular gland nut includes a top edge opposite of said contact edge, said top edge having at least one tool receiving arrangement.

9. The mounting system of claim 8, wherein said at least one tool receiving arrangement includes a pocket in said top edge.

10. The mounting system of claim 9, wherein said pocket is a plurality of cylindrical openings extending into said top edge that are spaced about said top edge.

11. The mounting system of claim 9, wherein said pocket is a plurality of slotted pockets extending into said top edge that are spaced about said top edge.

12. The mounting system of claim 1, wherein the associated subplate further includes a lower subplate surface and the mounting opening is a through hole extending from the upper subplate surface to the lower subplate surface, the bottom ledge being spaced between the upper and lower subplate surfaces.

13. The mounting system of claim 1, wherein the bottom ledge is spaced from the lowest extend of the mounting opening.

14. The mounting system of claim 1, wherein said gland nut is a unified structure with said receiver.

15. The mounting system of claim 1, wherein said plate is a fixture plate and said subplate is connectable to a machine table.

16. The mounting system of claim 1, wherein said locking arrangement is near said distal end and said shank further includes a bearing surface between said head and said locking arrangement to at least partially align said shaft axis and said passage axis.

17. The mounting system of claim 1, wherein said locking arrangement includes at least one ball that can be forced radially outwardly to engage said mating locking arrangement in said inner passage.

18. The mounting system of claim 1, wherein said at least one ball includes a pair of opposing balls that can be forced radially outwardly in opposite directions to engage said mating locking arrangement.

19. The mounting system of claim 1, wherein said locking arrangement includes a threaded engagement between said shaft and said inner passage.

20. A receiver arrangement for a mounting system for securing a plate to a subplate, the associated plate having an upper plate surface and an opposing lower plate surface with a through hole extending from the upper plate surface to the lower plate surface, the associated subplate having an upper subplate surface facing said lower plate surface and having a mounting opening extending into the upper subplate surface, the mounting opening having opening peripheral surface generally extending between the upper subplate surface and a bottom extent, the mounting opening further including a bottom ledge and at least one opening bearing surface, said receiver arrangement comprising: an annular receiver bushing having an inner passage extending about a passage axis, said bushing further including a radially outwardly facing peripheral bushing surface, said inner passage being shaped to receive a shaft portion of an associated shank, said passage having a mating locking arrangement allowing a locking arrangement of the associated shank to selectively interengage with said receiver bushing and secure the associated shank relative to said receiver thereby securing the associated plate to the associated subplate, said outer bushing surface having at least one receiver bearing surface shaped to engage the opening bearing surface of the associated subplate and align said receiver laterally in the opening, said bushing further including a downwardly facing support edge; and an annular gland nut having an outer diameter thread configured to threadingly engage an inside diameter thread in the peripheral surface of the associated mounting opening and having a contact edge configured to engage said receiver when said gland nut is tightened in the mounting opening, said gland nut forcing said support edge of said receiver against the bottom ledge of the mounting opening as said nut is tightened into the mounting opening thereby securing said receiver axially in the mounting opening.

21. The receiver arrangement of claim 20, wherein said receiver bushing includes a bushing top extent and an opposite bushing bottom extent, said bushing bottom extent including said support edge.

22. The receiver arrangement of claim 20, wherein the bottom ledge of the mounting opening is spaced from the opening bottom extent.

23. The receiver arrangement of claim 22, wherein said peripheral bushing surface of said annular receiver bushing is a first peripheral bushing surface near said bushing bottom extent and said receiver further includes a second peripheral bushing surface near said top bushing extent, said gland nut extending about said second peripheral bushing surface, said first bushing surface including said receiver bearing surface.

24. The receiver arrangement of claim 23, wherein said first peripheral bushing surface has a first diameter and said second peripheral bushing surface has a second diameter, said first diameter being greater than said second diameter forming a receiver ledge between said first and second peripheral surfaces, said contact edge of said gland nut engaging said receiver ledge thereby forcing said receiver against the bottom ledge of the associated mounting opening.

25. The receiver arrangement of claim 20, wherein said annular gland nut include a top edge opposite of said contact edge, said top edge having at least one tool receiving arrangement.

26. The receiver arrangement of claim 25, wherein said at least one tool receiving arrangement includes a pocket in said top edge.

27. The receiver arrangement of claim 26, wherein said pocket is a plurality of cylindrical openings extending into said top edge that are spaced about said top edge.

28. The receiver arrangement of claim 20, wherein the associated subplate further includes a lower subplate surface and the mounting opening is a through hole extending from the upper subplate surface to the lower subplate surface, the bottom ledge being spaced between the upper and lower subplate surfaces.

29. The receiver arrangement of claim 20, wherein said gland nut is a unified structure with said receiver.

30. The receiver arrangement of claim 20, wherein said mating locking arrangement includes a conical portion in said inner passage, the locking arrangement of the associated shank including at least one ball that can be forced radially outwardly to engage said conical portion.

31. The receiver arrangement of claim 20, wherein said at least one ball includes a pair of opposing balls that can be forced radially outwardly in opposite directions to engage said mating locking arrangement.

32. The receiver arrangement of claim 20, wherein said locking arrangement includes a threaded engagement between said shaft and said inner passage.
